(19) United States
(12) Patent Application Publication
(10) Pub. No.: US 2012/0083204 A1
(43) Pub. Date: Apr. 5, 2012

(54) Method and Apparatus for Controlling Access

(75) Inventor: Brian Alexander Martin, Farnham (GB)

(73) Assignee: NOKIA CORPORATION, Espoo (FI)

(21) Appl. No.: 12/897,283

(22) Filed: Oct. 4, 2010

(51) Int. Cl. H04W 28/26; H04W 48/16

(52) U.S. Cl. 455/26.1; 455/509

(57) ABSTRACT

In accordance with an example embodiment of the present invention, an apparatus such as a terminal receives a message comprising cell reservation information, stores information indicating whether the terminal is a machine-type terminal, sends an attachment request toward a network in dependence of the cell reservation information and the information indicating whether the apparatus is comprised in a machine-type terminal, wherein the cell reservation information comprises cell reservation information relating exclusively to machine-type terminals.

### TECHNICAL FIELD

The present application relates generally to connectivity and/or access control in the context of distributed or cellular communications.

### BACKGROUND

Distributed, or peer-to-peer, and cellular communications can take place in the contexts of person-to-person, person-to-machine, machine-to-person, or machine-to-machine communication.

Person-to-person communication comprises inter-person telephone communications, for example. Cellular networks originally designed to support person-to-person communications have been used also for machine-centric communication. This may entail a person accessing a network such as the Internet using a personal communications device, or a home security appliance reporting data to a central repository using a cellular network as a communication medium, for example. In general, machine-centric communications may be any communication where at least one endpoint is not a person but a machine. In detail, machine-centric communication comprises communication between two automated machines.

The Third Generation Partnership Project, 3GPP, has studied requirements relating to machine-centric communications. Machine-centric communications have characteristics that differ from person-centric communications, for example where both endpoints are static, automated machines mobility procedures may be rarely needed. In some cases, the type of machine affects the types of communication required, for example a closed-circuit camera feed may only require a constant quality of service selected as suitable but not excessive for conveying a video feed from the unit. In such a case, procedures for dynamically changing the quality of service may be rarely, if ever, needed.

Another example of a specialized machine application is automated metering, where only very limited and predictably used transmission capability may be needed as compared to human communication, where occasional need for high throughput is possible to support video telephony, for example.

### SUMMARY

Various aspects of examples of the invention are set out in the claims.

According to a first aspect of the present invention, there is provided an apparatus, comprising a receiver configured to receive a broadcasted message comprising cell reservation information, memory configured to store information indicating whether the apparatus is comprised in a machine-type terminal, a transmitter configured to send an attachment request toward a network in dependence of the cell reservation information and the information indicating whether the apparatus is comprised in a machine-type terminal, wherein the cell reservation information comprises cell reservation information relating exclusively to machine-type terminals.

According to a second aspect of the present invention, there is provided an apparatus, comprising at least one processor, at least one memory including computer program code, the at least one memory and the computer program code configured to, with the at least one processor, cause the apparatus to at least receive information relating to a request to associate a terminal with a cell, obtain an indication concerning whether the terminal is a machine-type terminal, determine whether the terminal is barred from the cell based at least in part on the information, the indication and machine-type cell reservation information relating to the cell.

According to a third aspect of the present invention, there is provided a computer program product comprising a computer-readable medium bearing computer program code embodied therein for use with a computer, the computer program code comprising code for receiving a broadcasted message comprising cell reservation information, code for storing information indicating whether the apparatus is comprised in a machine-type terminal, code for sending an attachment request toward a network in dependence of the cell reservation information and the information indicating whether the apparatus is comprised in a machine-type terminal, wherein the cell reservation information comprises cell reservation information relating exclusively to machine-type terminals.

According to a fourth aspect of the present invention, there is provided A computer program product comprising a computer-readable medium bearing computer program code embodied therein for use with a computer, the computer program code comprising, code for receiving information relating to a request to associate a terminal with a cell, code for obtaining an indication concerning whether the terminal is a machine-type terminal, and code for determining whether the terminal is barred from the cell based at least in part on the information, the indication and machine-type cell reservation information relating to the cell.

### BRIEF DESCRIPTION OF THE DRAWINGS

For a more complete understanding of example embodiments of the present invention, reference is now made to the following descriptions taken in connection with the accompanying drawings in which:

FIG. 1 illustrates an arrangement where some embodiments of the invention may be practiced.

FIG. 2 illustrates an example apparatus 201 capable of supporting embodiments of the present invention.

FIG. 3 is a flow diagram showing operations related to some embodiments of the invention; and

FIG. 4 is a flow diagram showing operations related to some embodiments of the invention.

### DETAILED DESCRIPTON OF THE DRAWINGS

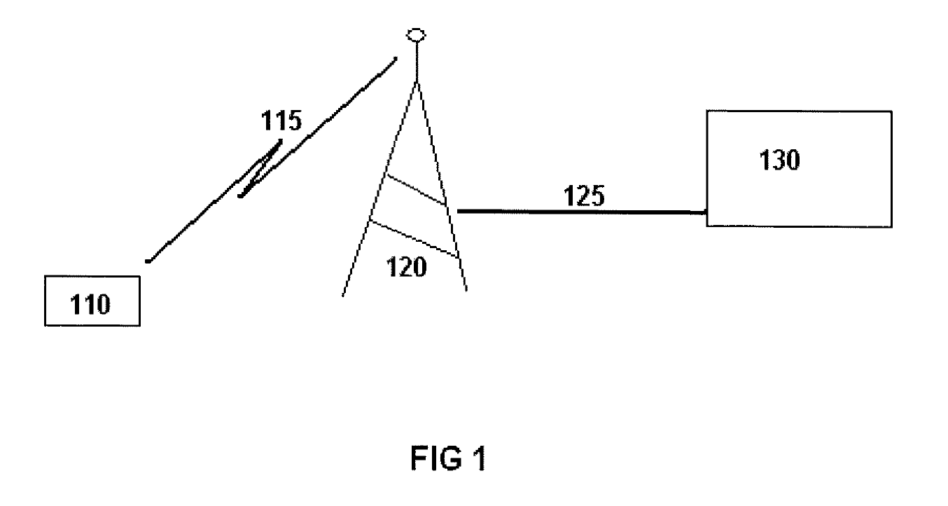

An example embodiment of the present invention and its potential advantages are understood by referring to FIGS. 1 through 4 of the drawings.

FIG. 1 illustrates an arrangement where some embodiments of the invention may be practiced. FIG. 1 illustrates apparatus 110, which may be for example a cellular telephone, in this context known as non-machine type terminal, or an automated machine, in this context also known as a machine-type terminal. Examples of automated machines include closed-circuit television monitoring machines and automated meters such as electricity or gas meters. Non-machine type terminals may be known as user-centric terminals. Apparatus 110 may be configured to autonomously, without user intervention, transmit information stored in an internal or external memory of apparatus 110. Apparatus 110 may be configured to, responsive to determining that information stored in a memory of apparatus 110 needs to be transmitted, cause a connection 115 to be established. Apparatus 110 may be configured to transmit information periodically, responsive to a determination that a predetermined amount of information has accumulated in a memory of apparatus 110 or responsive to a trigger event. Examples of trigger events include detection of motion in a motion sensor, detection of a predetermined temperature in a temperature sensor, determination that a temperature has changed by a predetermined number of degrees in a predetermined amount of time, or a determination that a usage rate of electricity or gas changes. In some embodiments, a trigger event is reception in apparatus 110 of a request to provide data.

Connection 115 allows apparatus 110 to transmit information to base station 120. Connection 115 may also allow apparatus 110 to receive information from base station 120. Connection 115 may be a connection according to wideband code division multiple access, WCDMA, global system for mobile communications, GSM, long term evolution, LTE, or other wireless technology. In some embodiments connection 115 may be a wire-line connection instead of a wireless connection. Connection 115 may comprise an uplink connection for conveying information from apparatus 110 to base station 120. Connection 115 may comprise a downlink for conveying information from base station 120 to apparatus 110. Base station 120 comprises equipment configured to support connection 115, for example in embodiments where connection 115 is in accordance with WCDMA technology, base station 120 comprises at least equipment arranged to support WCDMA connections. Base station 120 is herein referred to as a base station, but is should be understood that in some embodiments, other terms such as access point 120 might be considered more accurate and such embodiments are not to be excluded from the scope of the present invention by this terminological choice.

Connection 115 may comprise resources reserved for the connection. Radio resources of a wireless connection 115 may comprise frequency, time, code or space resources, for example. Resources reserved for connection 115 may comprise a certain time-slice on a certain spreading code, which is used to spread a signal over a certain frequency band. In embodiments where connection 115 is wire-line, resources of the connection may comprise timeslots allocated to connection 115. Connection 115 may comprise encryption, authentication and charging aspects handled by the system in which base station 120 is comprised. An active connection 115 may comprise data transmission, or at least periodic keep-alive packets arranged to prevent timeout timers from dismantling connection 115. Transmitting, receiving and processing keep-alive packets consume a certain amount of energy in apparatus 110 and base station 120, wherefore connection 115, when active, consumes energy even when no active data transmission is ongoing.

Backbone connection 125 conveys information between base station 120 and core network 130. Core network 130 may be connected to more than one radio-access network, each radio-access network comprising a plurality of base stations. Core network 130 may be shared between network operators. Backbone connection 125 may be wire-line or wireless, an example a wireless backbone connection 125 is a microwave link interconnecting base station 120 and core network 130. Core network 130 may comprise a gateway node, not illustrated, operatively connected to external networks. In an example embodiment, apparatus 110 may be configured to transmit information via base station 120 and core network 130 to a proprietary network or a corporation that owns apparatus 110. An example of such an arrangement is one where apparatus 110 is an electric meter configured to transmit information to corporate network of an electric utility corporation.

In cases where apparatus 110 transmits information infrequently, it may be advantageous to release connection 115 when no transmission is ongoing in order to release the resources allocated to connection 115 for active communications by other apparatuses, or alternatively or additionally to conserve energy spent in keeping connection 115 active. Whether it is advantageous to release connection 115 in-between transmissions may depend on, for example, the ratio of transmission gaps to lengths of transmissions wherein a transmission gap is a length of time from the end of a transmission to the start of a next transmission.

Before apparatus 110 can use connection 115, it must roam to a cell controlled by base station 120. Base station 120 may be configured to control more than one cell, whereby the cells may be separated from each other directionally or by operating in different frequency ranges, for example. Roaming situations may be encountered by apparatus 110 as it moves from an area of one cell to an area of another cell, for example. A stationary apparatus 110 may encounter a roaming situation when, for example, a base station with which it is associated experiences a failure. In this case, apparatus 110 may be configured to attempt to become associated with another base station 120.

Prior to transmitting an attachment request to base station 120, apparatus 110 may be configured to receive information concerning a cell controlled by base station 120. The information may be broadcast by base station 120, by which it is meant that base station 120 may send the information without addressing it to any terminal in particular, allowing and intending for plural terminals to receive it. Alternatively terminal 110 might request the information and responsively receive it from base station 120. The broadcasted information may be called system information. System information may comprise information usable by apparatus 110 in compiling an attachment request for transmission to base station 120. For example, system information may comprise an identifier of a network in which the cell is comprised. The identifier may identify an operator of the network. System information may comprise information concerning which terminals are allowed to associate with the cell.

System information may comprise cell reservation information for the cell. Cell reservation information may restrict associations to the cell, wherein terminals that receive the system information may be configured to determine based at least in part on the cell reservation information that they are not allowed to associate with the cell. From the point of view of the terminals affected, the cell may be considered as barred to them. If a terminal 110 transmits an association request to a cell from which it is barred, base station 120 may be configured to ignore the request, or to explicitly decline the association request by transmitting a message to the terminal 110 responsive to the association request. The message may comprise an indication that the cell is barred to the terminal 110.

Cell restriction policy may be defined by an operator of a network in which the cell is comprised. Some operators may desire to limit access to their network of machine-type terminals, for example. One reason for this may be that in case of failure of an adjacent cell, a large number of machine-type terminals in the failed cell would otherwise attempt to associate with a cell in their network. Such associations could create an unwanted surge in signaling. On the other hand, barring machine-type terminals from certain cells allows operators to separate roaming policies for user-centric and machine-type terminals. Certain cells may be designed for machine-type traffic, in which case an operator may choose to bar machine-type terminals from other cells. Machine-type cells may have lower capacity and less adaptability, for example, since machine-centric communication may be less adaptive in nature. Guiding such traffic to machine-type cells may leave capacity in other cells free for human users. Limiting access to a cell by machine-type terminals may be accomplished by including in system information cell reservation information relating exclusively to machine-type terminals in addition to normal cell reservation information relating to all terminals. Cell reservation information relating exclusively to machine-type terminals may be known as machine-type cell reservation information. Other cell reservation information, meaning cell reservation information not pertaining exclusively to machine-type terminals, may comprise information indicating the cell is reserved for future use, for operator use and/or for a closed subscriber group, for example.

A machine-type terminal receiving system information may deduce whether the cell the information relates to is barred to it or no. A machine-type terminal may be furnished with information that it is a machine-type terminal, which information may be stored in a memory of terminal 110, for example. In a first group of embodiments of the invention, cell reservation information relating exclusively to machine-type terminals is a single value comprised in system information. In these embodiments, when a machine-type terminal receives system information, it may first be configured to check if the cell is indicated as reserved in other cell reservation information comprised in the system information. If the other cell reservation information indicates the cell is not reserved and machine-type cell reservation information indicates the cell as reserved, machine-type terminals 110 may be configured to consider the cell barred and non-machine-type terminals may be configured to consider the cell as not barred. If other cell reservation information indicates the cell as not reserved and machine-type cell reservation information is absent, both machine-type and non-machine-type terminals may be configured to consider the cell as not barred. If other cell reservation information indicates the cell as reserved and machine-type cell reservation information is absent, both machine-type and non-machine-type terminals may be configured to consider the cell as barred.

In a second group of embodiments, where machine-type cell reservation information indicates the cell as reserved and other cell reservation information indicates the cell as reserved, non-machine-type terminals may be configured to consider the cell as barred and machine-type terminals may be configured to consider the cell as not barred. In these embodiments, the machine-type cell reservation information overrides the other cell reservation information. In these embodiments, where other cell reservation information indicates the cell as reserved and system information doesn't comprise machine-type cell reservation information, both machine-type and non-machine-type terminals may be configured to consider the cell as barred.

In a third group of embodiments, machine-type cell reservation information indicates a priority level. In these embodiments, where machine-type cell reservation information is present and other cell reservation information indicates the cell as reserved, non-machine-type terminals may be configured to consider the cell as barred and machine-type terminals may be configured to consider the cell as not barred only if their priority exceeds the indicated priority. This way cells can be reserved for use for high-priority machine-type terminals which may comprise, for example, medical instruments monitoring vital functions of persons. In these embodiments, where machine-type cell reservation information is present and other cell reservation information indicates the cell as not reserved, non-machine type terminals may be configured to consider the cell as not barred and machine-type terminals may be configured to only consider the cell as not barred if their priority exceeds the indicated priority.

In some embodiments, cell reservation information comprises cell reservation information relating exclusively to terminals of a priority lower than a threshold priority. In these embodiments, where other cell reservation information indicates the cell as reserved and cell reservation information relating exclusively to terminals of a priority lower than a threshold priority indicates the cell as reserved to terminals of a priority lower than the threshold priority, terminals may be configured to consider the cell as not barred only if a priority of the terminal is higher than the threshold priority. In these embodiments, cell reservation information may or may not additionally comprise machine-type cell reservation information. Where cell reservation information in these embodiments comprises machine-type cell reservation information, terminals may be configured to determine whether a cell is barred to them in a like manner to embodiments where machine-type cell reservation information indicates a priority, the priority being the threshold priority.

Based on the foregoing, an operator may configure, for example, other cell reservation information to indicate the cell as not reserved and machine-type cell reservation information to indicate a priority level. In this case the cell would be configured to accept only non-machine type terminals and high-priority machine-type terminals, such as medical devices which should not be denied service.

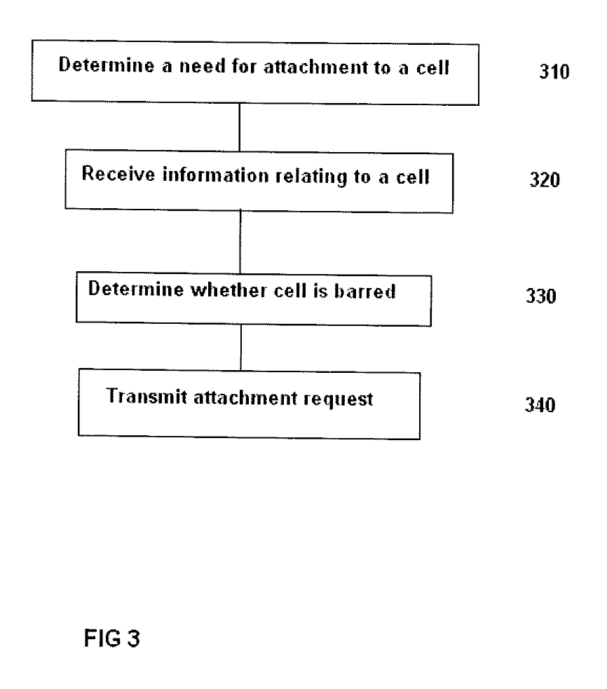

FIG. 3 is a flow diagram showing operations related to some embodiments of the invention. In phase 310 an apparatus, for example terminal 110, determines a need to attach to, or associate itself with, a cell or access point. This determination may occur responsive to a determination that the apparatus is being switched from a power-off state to a power-on state, responsive to a determination that a handover to a new cell is needed or responsive to a failure of a cell serving the apparatus previously, for example. In phase 320 the apparatus may receive information relating to a cell that is a candidate for attachment or association. The information may comprise a network or operator identifier, system information and cell reservation information. Cell reservation information may comprise machine-type cell reservation information, relating exclusively to machine-type terminals and other cell reservation information, for example. The information may be broadcasted, for example using a broadcast channel and/or frequency. Phase 320 may occur either before or after phase 310.

In phase 330 an apparatus may determine, based on the information and information about a terminal which is stored in the terminal, whether the cell the information relates to should be considered as barred to the apparatus. In phase 340 the apparatus may transmit an attachment or association request to a base station, such as base station 120, based on the determination of phase 330. In detail, the apparatus may be configured to transmit the request responsive to a determination that the cell is not barred to the apparatus and the apparatus may be configured to refrain from sending the request responsive to a determination that the cell is barred to the apparatus. Phases 310, 320, 330 and 340 may occur in a terminal such as terminal 110 or an apparatus comprised in a terminal, such as a control apparatus or processor, for example.

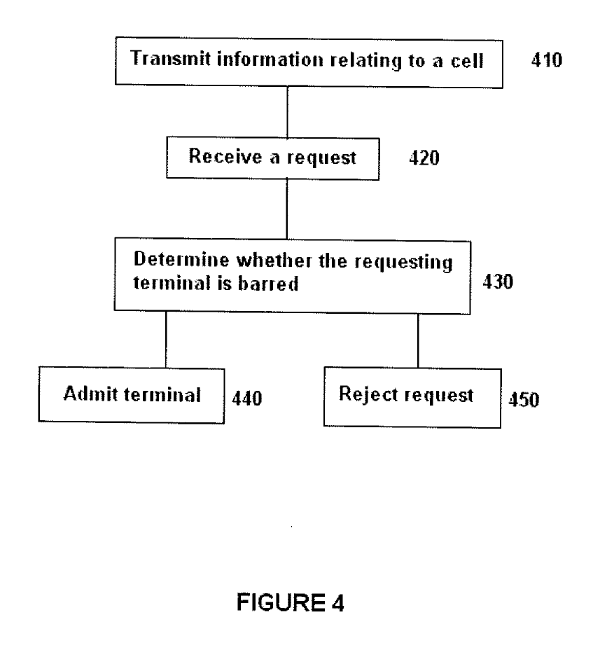

FIG. 4 is a flow diagram showing operations related to some embodiments of the invention. In phase 410 an apparatus such as, for example, base station 120 transmits information relating to a cell controlled by the apparatus. The information may correspond to information received in phase 320. The information may be broadcasted using predefined broadcast radio resources, which may comprise at least one frequency band, spreading code, timing scheme and/or orthogonal frequency combination. In phase 420 the apparatus may receive a request, for example a request from a terminal, to associate with, or attach to, the cell. The request may comprise an indication as to whether or not the requesting terminal is a machine-type terminal and/or subscriber identification information.

Responsive to receiving the request, it is determined whether to allow the request. This determination may be called an admission decision. This determination may be performed by the apparatus or a further network element, such as radio network controller or core network element. In case phase 430 is performed by a further network element, the apparatus may be configured to transmit information relating to the request to the further network element and to receive therefrom an indication of a result of the determination. The determination may be based at least in part on the indication whether or not the requesting terminal is a machine-type terminal and the transmitted information relating to the cell. The node making the determination may obtain the indication whether or not the requesting terminal is a machine-type terminal from the request or from a network node storing the indication. The node making the determination may request the network node storing the indication to provide the indication, wherein the node making the determination may provide subscriber identification information to the network node storing the indication and responsively receive the indication from the network node storing the indication.

To make the determination, the node making the determination may also obtain cell reservation information relating to the cell, the cell reservation information relating to the cell comprising machine-type cell reservation information and other cell reservation information.

Responsive to the determination being positive, the requesting terminal is informed of the determination by transmitting an acceptance message to the requesting terminal, phase 440. Responsive to the determination being negative, the request may be ignored, or alternatively the requesting terminal may be provided with a rejecting message, which may comprise an indication as to cause of the rejection, phase 450.

According to some embodiments, system information comprises information relating to machine-type terminals in addition to machine-type cell reservation information. Such information, which will be referred to as MTC information in this document, may comprise access class parameters, cell status information, reservation and/or cell access restriction parameters, for example. It is possible for a network to update MTC information by replacing previous MTC information in broadcasted system information with new MTC information. Machine-type terminals may be configured to receive an indication from the network that MTC information has been changed. The indication may be broadcast in a broadcast channel modification information message, for example. Non-machine type terminals may be configured to ignore the indication. Responsive to receiving the indication that MTC information has been changed, machine-type terminals may be configured to receive the updated MTC information from the updated system information broadcast.

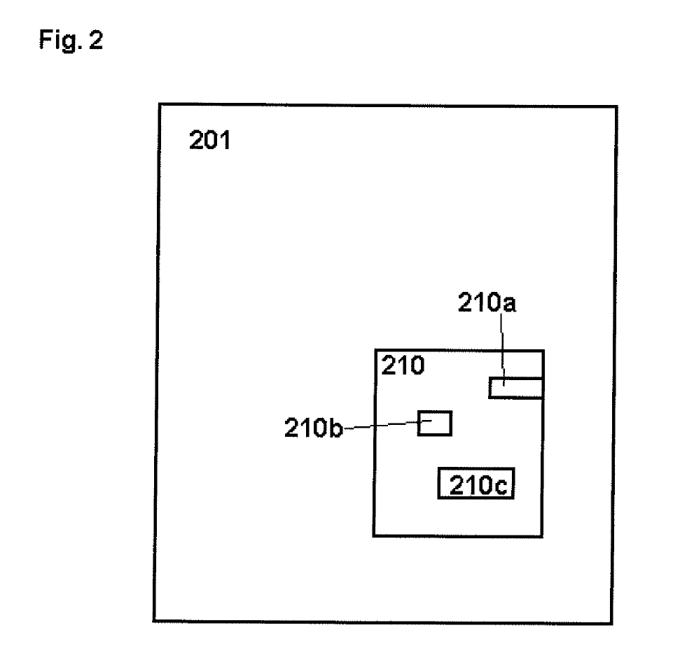

FIG. 2 illustrates an example apparatus 201 capable of supporting embodiments of the present invention. The apparatus may correspond to apparatus 110, base station 120 or a node in core network 130 of FIG. 1, for example. The apparatus is a physically tangible object, for example a mobile telephone, personal digital assistant, data dongle or a similar device. The apparatus may comprise a control apparatus 210, for example a digital signal processor, DSP, processor, field-programmable gate array, FPGA, application-specific integrated circuit, ASIC, chipset or controller. The apparatus may further comprise a transmitter and/or a receiver 210a configured to enable the apparatus 201 to connect to other apparatuses. A combination of transmitter and receiver may be called a transceiver. The apparatus may comprise memory 210b configured to store information, for example cell reservation information comprising machine-type cell reservation information relating exclusively to machine-type terminals. The memory may be solid-state memory, dynamic random access memory, DRAM, magnetic, holographic or other kind of memory. The apparatus may comprise logic circuitry 210c configured to access the memory 210b and control the transmitter and/or a receiver 210a. The logic circuitry 210c may be implemented as software, hardware or a combination of software and hardware. The logic circuitry may comprise a processing core. The logic circuitry 210c may execute program code stored in memory 210b to control the functioning of the apparatus 201 and cause it to perform functions related to embodiments of the invention. The logic circuitry 210c may be configured to initiate functions in the apparatus 201, for example the sending of data units via the transmitter and/or a receiver 210a. The logic circuitry 210c may be control circuitry. The transmitter and/or a receiver 210a, memory 210b and/or logic circuitry 210c may comprise hardware and/or software elements comprised in the control apparatus 210. Memory 210b may be comprised in the control apparatus 210, be external to it or be both external and internal to the control apparatus 210 such that the memory is split to an external part and an internal part. If the apparatus 201 does not comprise a control apparatus 210 the transmitter and/or a receiver 210a, memory 210b and logic circuitry 210c may be comprised in the apparatus as hardware elements such as integrated circuits or other electronic components. The same applies if the apparatus 201 does comprise a control apparatus 210 but some, or all, of the transmitter and/or a receiver 210a, memory 210b and logic circuitry 210c are not comprised in the control apparatus 210. In embodiments where apparatus 201 is a mobile user equipment, apparatus 201 may comprise at least one antenna.

Without in any way limiting the scope, interpretation, or application of the claims appearing below, a technical effect of one or more of the example embodiments disclosed herein is that cells can be selectively barred to machine-type terminals or non-machine-type terminals. Another technical effect of one or more of the example embodiments disclosed herein is that roaming control is separated for machine-type and non-machine type terminals. Embodiments of the present invention may be implemented in software, hardware, application logic or a combination of software, hardware and application logic. The software, application logic and/or hardware may reside on memory 210b, for example. If desired, part of the software, application logic and/or hardware may reside in control apparatus 210. In an example embodiment, the application logic, software or an instruction set is maintained on any one of various conventional computer-readable media. In the context of this document, a “computer-readable medium” may be any media or means that can contain, store, communicate, propagate or transport the instructions for use by or in connection with an instruction execution system, apparatus, or device, such as a computer, with one example of a computer described and depicted in FIG. 2. A computer-readable medium may comprise a computer-readable non-transitory storage medium that may be any media or means that can contain or store the instructions for use by or in connection with an instruction execution system, apparatus, or device, such as a computer. The scope of the invention comprises computer programs configured to cause methods according to embodiments of the invention to be performed.

If desired, the different functions discussed herein may be performed in a different order and/or concurrently with each other. Furthermore, if desired, one or more of the above-described functions may be optional or may be combined.

Although various aspects of the invention are set out in the independent claims, other aspects of the invention comprise other combinations of features from the described embodiments and/or the dependent claims with the features of the independent claims, and not solely the combinations explicitly set out in the claims.

It is also noted herein that while the above describes example embodiments of the invention, these descriptions should not be viewed in a limiting sense. Rather, there are several variations and modifications which may be made without departing from the scope of the present invention as defined in the appended claims.

What is claimed is:

1. An apparatus, comprising:
a receiver configured to receive a broadcasted message comprising cell reservation information;
memory configured to store information indicating whether the apparatus is comprised in a machine-type terminal;
a transmitter configured to send an attachment request toward a network in dependence of the cell reservation information and the information indicating whether the apparatus is comprised in a machine-type terminal;
wherein the cell reservation information comprises cell reservation information relating exclusively to machine-type terminals.

2. An apparatus according to claim 1, wherein the cell reservation information relating exclusively to machine-type terminals comprises a cell reservation information element relating exclusively to machine-type terminals.

3. An apparatus according to claim 1, wherein the apparatus further comprises a processor configured to determine whether the cell reservation information indicates the cell is barred to the apparatus based on the information indicating whether the apparatus is comprised in a machine-type terminal, the cell reservation information relating exclusively to machine-type terminals and other cell reservation information comprised in the cell reservation information.

4. An apparatus according to claim 3, wherein the processor is configured to determine that the cell is not barred to the apparatus responsive to the cell reservation information relating exclusively to machine-type terminals being present and the other cell reservation information incidating the cell is reserved.

5. An apparatus according to claim 3, wherein the processor is configured to determine that the cell is not barred to the apparatus responsive to the cell reservation information relating exclusively to machine-type terminals indicating the cell as reserved for machine-type terminals of a priority lower than an threshold priority, the other cell reservation information indicating the cell as reserved, and determining that a priority of the terminal in which the apparatus is comprised being higher than the threshold priority.

6. An apparatus according to claim 1, wherein the processor is configured to determine that the cell is not barred to the apparatus responsive to the cell reservation information comprising information relating exclusively to terminals of a priority lower than a threshold priority indicating the cell as reserved for terminals of a priority lower than the threshold priority, other cell reservation information indicating the cell as reserved, and determining that a priority of the terminal in which the apparatus is comprised is higher than the threshold priority.

7. An apparatus according to claim 3, wherein the processor is configured to determine that the cell is barred to the apparatus based on the the cell reservation information relating exclusively to machine-type terminals being present and the other cell reservation information not indicating the cell as reserved.

8. A user equipment comprising an apparatus according to claim 1 and at least one antenna.

9. A method, comprising:
receiving a broadcasted message comprising cell reservation information;
storing information indicating whether the apparatus is comprised in a machine-type terminal;
sending an attachment request toward a network in dependence of the cell reservation information and the information indicating whether the apparatus is comprised in a machine-type terminal;
wherein the cell reservation information comprises cell reservation information relating exclusively to machine-type terminals.

10. An apparatus, comprising:
at least one processor; and
at least one memory including computer program code
the at least one memory and the computer program code configured to, with the at least one processor, cause the apparatus to perform at least the following:
receive information relating to a request to associate a terminal with a cell;
obtain an indication concerning whether the terminal is a machine-type terminal; and
determine whether the terminal is barred from the cell based at least in part on the information, the indication and machine-type cell reservation information relating to the cell.

11. An apparatus according to claim 10, wherein the apparatus is comprised in a base station.

12. An apparatus according to claim 10, wherein the apparatus is comprised in a core network node.

13. An apparatus according to claim 12, wherein the at least one memory and the computer program code are configured to, with the at least one processor, cause the apparatus to obtain the indication by requesting it from a node storing the indication, wherein the requesting comprises providing subscriber identification information to the node storing the indication.

14. An apparatus according to claim 11, wherein the at least one memory and the computer program code are configured to, with the at least one processor, cause the apparatus to obtain the indication from the request to associate a terminal with a cell.

15. An apparatus according to claim 12, wherein the at least one memory and the computer program code are configured to, with the at least one processor, cause the apparatus to transmit an indication concerning a result of the determination to a base station.

16. A method, comprising:
receiving information relating to a request to associate a terminal with a cell;
obtaining an indication concerning whether the terminal is a machine-type terminal; and
determining whether the terminal is barred from the cell based at least in part on the information, the indication and machine-type cell reservation information relating to the cell.

17. A method, comprising:
receiving in a machine-type terminal an indication that machine-type system information has been updated;
responsive to receiving the indication, receiving updated system information from a broadcasted system information message.

18. A computer program product comprising a computer-readable medium bearing computer program code embodied therein for use with a computer, the computer program code comprising:
code for receiving a broadcasted message comprising cell reservation information;
code for storing information indicating whether the apparatus is comprised in a machine-type terminal;
code for sending an attachment request toward a network in dependence of the cell reservation information and the information indicating whether the apparatus is comprised in a machine-type terminal;
wherein the cell reservation information comprises cell reservation information relating exclusively to machine-type terminals.

19. A computer program product comprising a computer-readable medium bearing computer program code embodied therein for use with a computer, the computer program code comprising:
code for receiving information relating to a request to associate a terminal with a cell;
code for obtaining an indication concerning whether the terminal is a machine-type terminal; and
code for determining whether the terminal is barred from the cell based at least in part on the information, the indication and machine-type cell reservation information relating to the cell.
